(19) United States
(12) Patent Application Publication
(10) Pub. No.: US 2024/0344881 A1
(43) Pub. Date: Oct. 17, 2024

(54) Sun Exposure Monitor and Sunscreen Storage Wearable Device

(71) Applicant: Nicholas Mitrano, Lake Peekskill, NY (US)

(72) Inventor: Nicholas Mitrano, Lake Peekskill, NY (US)

(21) Appl. No.: 18/408,813

(22) Filed: Jan. 10, 2024

Related U.S. Application Data
(60) Provisional application No. 63/495,656, filed on Apr. 12, 2023.

(51) Int. Cl. G01J 1/42; G08B 21/18

(52) U.S. Cl. CPC G01J 1/429; G08B 21/182

(57) ABSTRACT

A sun exposure monitor, alarm, and sunscreen storage wearable device for storing and dispensing sunscreen and providing alert notifications when excessive sun exposure is detected. The wearable device is in the form of a band or bracelet worn around the wrist and includes a reservoir for storing and dispensing sunscreen for easy application. A UV sensor detects the sun exposure and visual and audible notifications are generated when excessive sun exposure is detected. The device is waterproof, durable and includes a display device to display visual notification, current time, and temperature. The device is powered by a rechargeable battery that can be recharged using a charging port.

### CROSS-REFERENCE TO RELATED APPLICATION

The present application claims priority to, and the benefit of, U.S. Provisional Application No. 63/495,656, which was filed on Apr. 12, 2023, and is incorporated herein by reference in its entirety.

### FIELD OF THE INVENTION

The present invention generally relates to the field of wearable devices. More specifically, the present invention relates to a novel bracelet device for children and adults that reminds the wearer to apply sunscreen. The device includes a small reservoir and dispenser on the wristband section that houses and releases a small amount of sunscreen for convenient application. The device also includes a UV sensor and microprocessor for determining sun exposure and for providing visual and audible notification. The device helps reduce the chance of sunburn, overheating, dehydration, and other ailments while enjoying warm weather. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals who spend long hours outdoors such as on the beach, around pools, and for outdoor work or activities where individuals are exposed to the harmful effects of ultraviolet (UV) radiation from the sun. Commonly, to safeguard their skin and prevent sunburn and skin diseases, individuals apply sunscreen multiple times per day. However, individuals have to constantly rummage through a purse or backpack to find sunscreen which can be frustrating. This acts as a deterrent for individuals to apply sunscreen regularly, leaving them vulnerable to sunburn and increasing the risk of skin damage over time. Many individuals even forget to carry sunscreen. UV exposure and sunburn can be painful and may lead to skin conditions, including skin cancer. Individuals desire a more accessible solution to promote consistent sunscreen application and ensure adequate protection against harmful UV radiation.

When individuals spend time outdoors, they are unaware of the extent of the UV exposure. This can lead to increased exposure. Currently, there is no means for alerting individuals about the level of UV radiations. Individuals desire a device that can alert them to UV exposure.

Therefore, there exists a long felt need in the art for a wearable device such as a bracelet device that can store sunscreen for dispensing same when required by an individual. There is also a long felt need in the art for a wearable device that alerts users of the level of UV radiation. Additionally, there is a long felt need in the art for a novel wearable device that provides alerts to a wearer of the device for applying sunscreen. Moreover, there is a long felt need in the art for a wearable device that eliminates the requirement of carrying a separate sunscreen container. Further, there is a long felt need in the art for a wearable device that enhances the overall sun protection strategy and reduces the risk of sunburn and skin damage. Furthermore, there is a long felt need in the art for a wearable device that helps mitigate the risks associated with excessive UV exposure. Finally, there is a long felt need in the art for a wearable device that enables users to always keep sunscreen on themselves, offering convenient reapplication while at the beach, pool, traveling, working outdoors, and more.

The subject matter disclosed and claimed herein, in one embodiment thereof, comprises a sunburn alarm and sunscreen storage wearable device designed to be worn around a wrist. The wearable device includes a display device for displaying current time, temperature, and UV exposure notification. The UV exposure notification is based on a UV index calculated from the UV rays incident on a UV sensor which is integrated in the device. The wearable device includes a reservoir in the wrist band of the device, the reservoir is configured to store sunscreen and includes a nozzle for dispensing the sunscreen from the reservoir. The reservoir is covered by a lid wherein the lid is removed to access the reservoir for dispensing and replenishing the sunscreen.

In this manner, the sunburn alarm and sunscreen storage wearable device of the present invention accomplishes all of the forgoing objectives and provides users with a bracelet or wristband that identifies sun exposure and provides audible and visual alerts when the sun exposure is excessive. A small reservoir and dispenser designed to store and release sunscreen enables easy application and also offering easy reapplication of the sunscreen outdoors. The device not only promotes healthy sun protection habits but also help mitigate the risks associated with excessive UV exposure.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wearable device designed to be worn around a wrist. The wearable device includes a display device for displaying current time, temperature, and a UV exposure notification, wherein the UV exposure notification is based on a UV index calculated from the UV rays incident on a UV sensor integrated in the device. The wearable device includes a reservoir in the wrist band of the device, the reservoir is configured to store sunscreen and includes a nozzle for dispensing the sunscreen from the reservoir. The reservoir is covered by a lid wherein the lid is removed to access the reservoir for dispensing and replenishing the sunscreen.

In yet another embodiment, a wrist band for storing sunscreen and providing sun exposure notification is disclosed. The wrist band includes a flexible and extendable band, a housing storing a plurality of electronic components and a display device, the plurality of electronic components that includes a UV sensor for detecting sun exposure, a microprocessor for determining a UV index based on the detected sun exposure, a speaker for playing out an alert message when the UV index is more than a threshold value, the display device displays a visual notification in the form of a sun with sun rays for indicating the sun exposure wherein the number of sun rays in the notification corresponds to the sun exposure.

In yet another embodiment, a wearable bracelet device for dispensing sunscreen for easy reapplication on the body of a user is disclosed. The device is designed to be worn around the wrist and includes a reservoir disposed in the band of the device, the reservoir stores sunscreen and includes a nozzle for dispensing the sunscreen therefrom, wherein the reservoir is covered with a lid which forms a planar portion of the band.

In yet another embodiment, a wearable device configured to remind a user about applying sunscreen is disclosed. The wearable device includes a UV sensor for detecting UV rays and a microprocessor for generating a UV index. A speaker is integrated in the device for generating an alert signal when the UV index is greater than a threshold value such as UV index “6”. The alert signal reminds the user to apply sunscreen. The speaker also generates alert signal periodically after a predetermined time such as 1 hour or more.

In yet another embodiment, the reservoir can be refilled via the lid and nozzle of the reservoir and can dispense the desired quantity of the sunscreen.

Advantages of the device of the present invention is that it enables users to always keep sunscreen on themselves, offering convenient reapplication while at the beach, pool, traveling, outdoor work/activities, and more. Further, the alerts help reduce the chance of sunburn, overheating, dehydration, and other ailments while enjoying warm weather.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a sunburn alarm and sunscreen reservoir wearable device of the present invention in accordance with the disclosed structure;

FIG. 2 illustrates a bottom view of the sunburn alarm and sunscreen reservoir wearable device of the present invention in accordance with the disclosed structure;

FIG. 3 illustrates a block diagram showing different electronic components and sensors included in the sunburn wrist alarm bracelet in accordance with the disclosed structure;

FIG. 4 illustrates a flow chart depicting a process of generating a visual and audible notification when the UV exposure is greater than a threshold in accordance with the disclosed structure;

FIG. 5 illustrates a flow diagram depicting use of the bracelet device for dispensing sunscreen from the reservoir in accordance with the disclosed structure;

FIG. 6 illustrates a user wearing the bracelet device around a wrist and applying the sunscreen dispensed from the device in accordance with the disclosed structure; and

FIG. 7 illustrates an enlarged view of the sunscreen reservoir used in the bracelet device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a wearable device such as a bracelet device that can store sunscreen for dispensing when required by an individual. There is also a long felt need in the art for a wearable device that alerts users of the level of UV radiation. Additionally, there is a long felt need in the art for a novel wearable device that provides alerts to a wearer of the device for applying sunscreen. Moreover, there is a long felt need in the art for a wearable device that eliminates the requirement of carrying a separate sunscreen. Further, there is a long felt need in the art for a wearable device that enhances the overall sun protection strategy and reduces the risk of sunburn and skin damage. Furthermore, there is a long felt need in the art for a wearable device that helps mitigate the risks associated with excessive UV exposure. Finally, there is a long felt need in the art for a wearable device that enables users to always keep sunscreen on themselves, offering convenient reapplication while at the beach, pool, traveling, during outdoor work/activities, and more.

The present invention, in one exemplary embodiment, is a wrist band for storing sunscreen and providing sun exposure notification. The wrist band includes a flexible and extendable band, a housing storing a plurality of electronic components and a display device, the plurality of electronic components that includes a UV sensor for detecting sun exposure, a microprocessor for determining a UV index based on the detected sun exposure, a speaker for playing out an alert message when the UV index is more than a threshold value, the display device displays a visual notification in the form of a sun with sun rays for indicating the sun exposure wherein the number of sun rays in the notification corresponds to the sun exposure. A reservoir in the wrist band stores sunscreen which is dispensed using a nozzle disposed in the reservoir, thereby enabling easy access to the sunscreen.

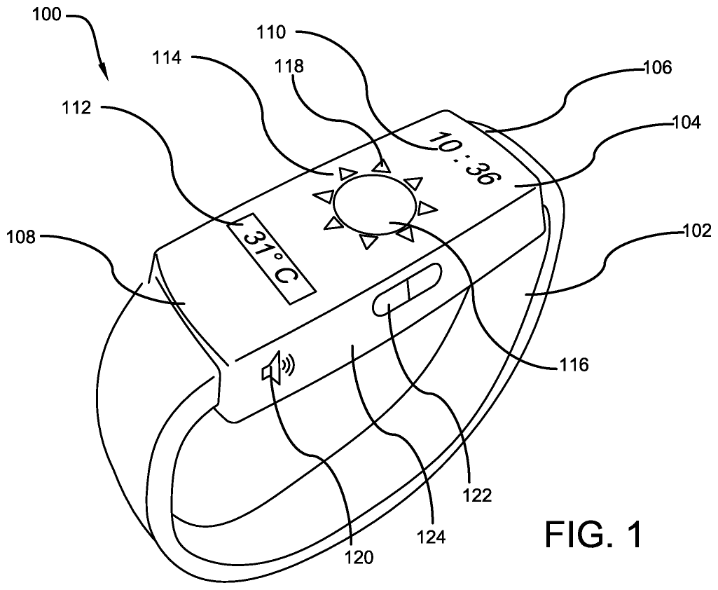

Referring initially to the drawings, FIG. 1 illustrates a perspective view of the sunburn alarm and sunscreen reservoir wearable device of the present invention in accordance with the disclosed structure. The wearable device 100 of the present invention is designed as a unisex bracelet or wrist band configured to be worn around the wrist of a user. The sunburn wrist alarm bracelet 100 includes a flexible band 102 which conforms around the wrist of a user wearing the bracelet device 100. In the preferred embodiment, the flexible band 102 forms a closed loop and is detachably or integrally connected to the opposite ends 106, 108 of the display device 104. The flexible band 102 can be made of any conventional polymer or rubber material.

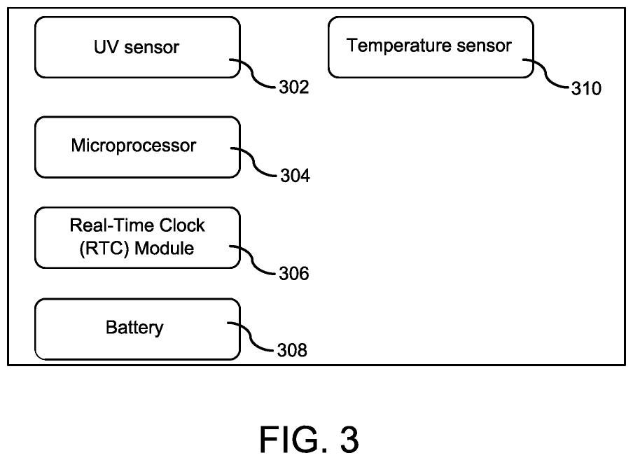

The display device 104 can be a touch-based device and is configured to display current time 110 and temperature 112. Ultraviolet rays visual notification 114 is also displayed on the display device 104 for indicating sun exposure. The notification 114 is preferably in the form of sun 116 with extending rays 118 wherein the number of rays indicate the sun exposure. The rays extending along the complete periphery of the sun 116 indicate maximum sun exposure. The notification 114 helps a wearer to be alerted for protection from sunburn. A built-in speaker 120 of the wearable device 100 is designed to produce an audible alert when excessive sun exposure is detected as described in FIG. 3. The speaker 120 can be a Piezoelectric speaker, traditional dynamic speaker, or any other type of speaker.

For recharging the device 100, a charging port 122 is integrated on a side surface 124 of the display device 104. The charging port 122 can be any conventional charging port such as mini-USB, micro-USB, USB-A, USB-C, or any other charging port used in conventional computing devices. The charging port 122 is designed to receive a charging port for recharging integrated battery of the bracelet device 100. The display device 104 can be a capacitive touchscreen, AMOLED touchscreen, LCD touchscreen, E-ink display, and more.

The device 100 is designed as a waterproof device and can be designed to have one of IPX5, IPX6, IPX7, or IPX8 ranking. Further, the device 100 is designed to be suitable for professional diving and can have 20 ATM rating.

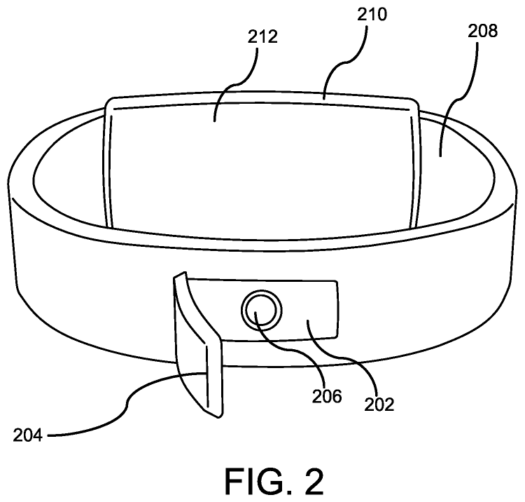

FIG. 2 illustrates a bottom view of the sunburn alarm and sunscreen reservoir wearable device of the present invention in accordance with the disclosed structure. The bracelet device 100 includes a sunscreen reservoir 202 preferably disposed inside a portion of the band 102 for storing a quantity of sunscreen. The sunscreen reservoir 202 preferably stores up to 10 ml of sunscreen and is covered by a pivoting lid 204 which forms a surface of the band 102 when it is in a closed orientation. The reservoir 202 includes a small nozzle 206 for dispensing a small quantity of the sunscreen from the reservoir 202. The reservoir 202 integrated in the device 100 helps users to apply sunscreen instantly and conveniently to protect themselves from sunburn and harmful UV rays.

For adjusting size of the band 102, a plurality of elastic members 208 are included in the band 102. While wearing the device 100 around the wrist by a user, the band 102 is extended when the elastic members 208 are stretched for enabling easy wearing of the device 100 by a user. The display device 104 is position on top of the control housing 210 which includes a plurality of electronic components as illustrated in FIG. 3. The bottom surface 212 of the control housing 210 is detachable, enabling a user to access the stored electronic components for repairing and replacing as per the requirements of the user.

FIG. 3 illustrates a block diagram showing different electronic components and sensors included in the sunburn wrist alarm bracelet in accordance with the disclosed structure. The device 100 includes a UV sensor 302 for detecting UV radiations falling thereon. The UV sensor 302 is preferably a photodetector that is sensitive to UV light and is configured to generate an electrical signal proportional to the intensity of UV rays falling thereupon. The electrical signal is transmitted to a microprocessor 304 which is configured to calculate a UV index from the received electrical signal. The UV index is a numerical rating indicating UV exposure and is displayed in the form of a notification 114 as illustrated in FIG. 1.

A Real-Time Clock (RTC) Module 306 is integrated in the device 100 for keeping track of the current time and date even when the bracelet device 100 is powered off or in sleep mode. In the preferred embodiment, the module 306 is a dedicated crystal oscillator to maintain accurate timekeeping, and the module 306 is battery-powered to ensure that the time is continuously updated. An integrated battery 308 which can be a button battery or Li-Ion battery is configured for providing electric power to the device 100. The battery 308 is recharged using external electric supply received via the connector 122 as illustrated in FIG. 1. A temperature sensor 310 is used for measuring ambient temperature and displays on the display device 102.

The microprocessor 304 used in the device 100 can be any of the conventional processor and is preferably a low-power microprocessor. The microprocessor 304 is also configured to send an instruction signal to the speaker 120 when the UV index is above a threshold value, enabling the speaker 120 to generate an alert sound for alerting a user.

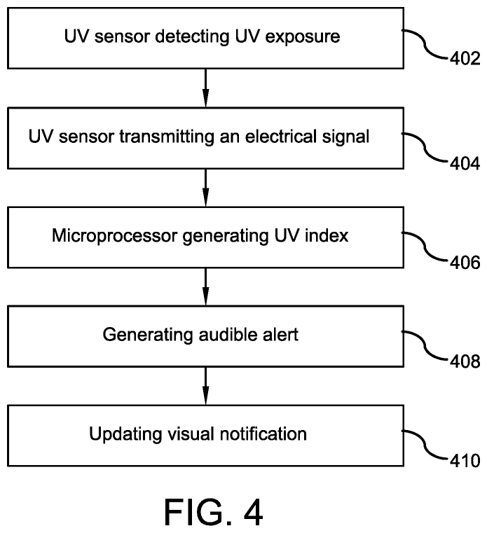

FIG. 4 illustrates a flow chart depicting a process of generating a visual and audible notification when the UV exposure is greater than a threshold in accordance with the disclosed structure. Initially, the UV sensor 302 detects UV rays falling on the display device 104 and generates an electrical signal based on detection of the UV rays (Step 402). The sensor 302 is configured to generate the electrical signal in real time when the UV rays incident on the display device 102. Then, the UV sensor 302 transmits the electrical signal in real-time to the microprocessor 304 (Step 404). Thereafter, the microprocessor 304 generates an UV index based on the received electrical signal for determining UV exposure level (Step 406).

In different embodiments of the present invention, the UV index ranges from 0 to 11 and more wherein, 0-2 corresponds to low UV exposure, 3-5 corresponds to moderate sun exposure, 6-7 corresponds to high exposure, and 8-11 corresponds to very high exposure. The microprocessor 304 sends an alert signal to the speaker when the UV index is 6 or more enabling the speaker to generate an audible alert signal (Step 408). The visual notification 114 is updated in real time based on the detected UV index wherein the rays 118 extending from the sun 116 increases in both number and size when higher UV index is detected (Step 410). In some embodiments, color of the notification 114 changes to red when the UV index of more than 8 is detected and is yellow when the UV index is less than 8. In one embodiment, the speaker 120 plays an alert message “Apply sunscreen” when the UV index of 8 or more is determined by the microprocessor 304.

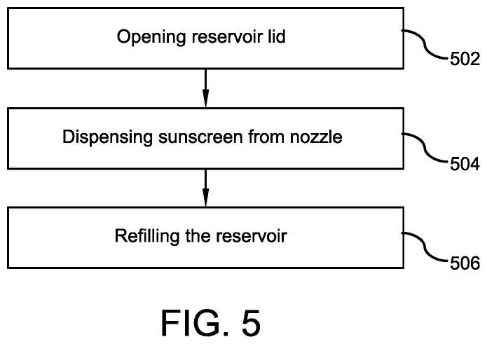

FIG. 5 illustrates a flow diagram depicting use of the bracelet device for dispensing sunscreen from the reservoir in accordance with the disclosed structure. Initially, a user opens the lid 204 to access the reservoir 202 for sunscreen (Step 502). A user can remove the bracelet device 100 from the wrist for accessing the lid 204. Once the lid is opened, a small quantity of the sunscreen can be dispensed from the reservoir 202 via the nozzle dispensed in the reservoir (Step 504). The reservoir 202 can be refilled when it becomes empty by using any conventional sunscreen using a narrow tube (not shown) (Step 506).

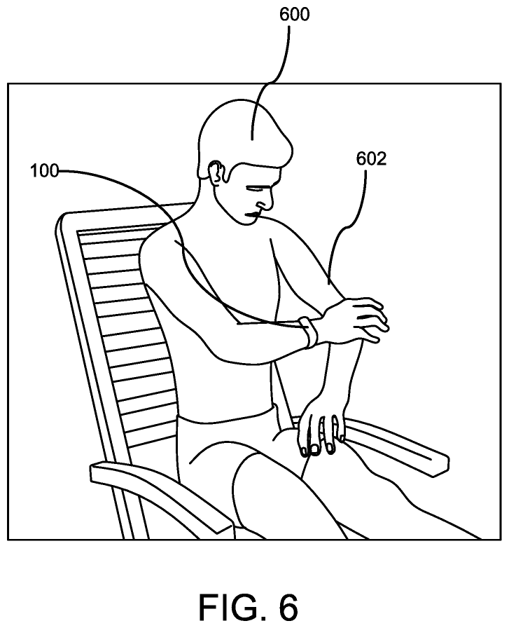

FIG. 6 illustrates a user wearing the bracelet device around a wrist and applying the sunscreen dispensed from the device in accordance with the disclosed structure. The user 600 can dispense a desired quantity of the sunscreen from the reservoir 202 and apply on body 602. The device 100 eliminates sifting through items in a bag or separately carrying a sunscreen bottle or container and therefore, enables easy application of the sunscreen.

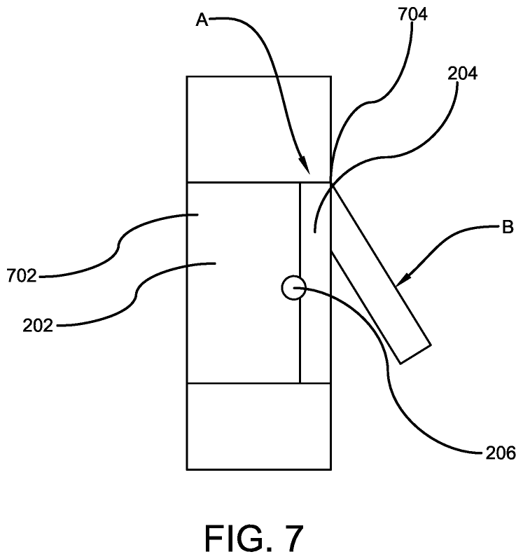

FIG. 7 illustrates an enlarged view of the sunscreen reservoir used in the bracelet device of the present invention in accordance with the disclosed structure. The reservoir 202 has a thickness substantially equal or about 90% of the thickness of the band 102. The inner walls 702 of the reservoir 202 are non-greasy and the stored sunscreen does not adhere or stick to the inner walls 702. Further, the nozzle 206 is used for dispensing the sunscreen and the reservoir 202 is not required to be pressed for dispensing the sunscreen. The sunscreen reservoir 202 forms a portion of the band 102 and the lid 204 covers the reservoir 202 and in a closed state becomes planar to the band 102 (shown by arrow A). The lid 204 is pivotable along the pivoting point 704 to access the reservoir 202 (shown by arrow B).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sunburn alarm and sunscreen reservoir wearable device”, “bracelet device”, “sunburn wrist alarm bracelet”, “wearable device”, and “device” are interchangeable and refer to the sunburn alarm and sunscreen reservoir wearable device 100 of the present invention.

Notwithstanding the forgoing, the sunburn alarm and sunscreen reservoir wearable device 100 of the present invention can be of any suitable size and configuration as is known in the art without affecting the overall concept of the invention, provided that it accomplishes the above stated objectives. One of ordinary skill in the art will appreciate that the sunburn alarm and sunscreen reservoir wearable device 100 as shown in the FIGS. 1-2 are for illustrative purposes only, and that many other sizes and shapes of the sunburn alarm and sunscreen reservoir wearable device 100 are well within the scope of the present disclosure. Although the dimensions of the sunburn alarm and sunscreen reservoir wearable device 100 are important design parameters for user convenience, the sunburn alarm and sunscreen reservoir wearable device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sun exposure wrist bracelet for monitoring UV exposure, the sun exposure wrist bracelet comprising:
a sun exposure bracelet for monitoring UV exposure having a flexible band, a display, and a sunscreen reservoir;
wherein said flexible band forming a closed loop to selectively conform around a wrist of a user;
wherein said display having a touch-based display including a display of a current time, a current temperature, and a UV exposure;
wherein said sunscreen reservoir disposed inside a portion of said flexible band having a quantity of sunscreen stored therein; and
further wherein said sunscreen reservoir having a pivoting lid and a nozzle for dispensing said sunscreen.

2. The sun exposure bracelet of claim 1, wherein said sunscreen reservoir and said pivoting lid forming a portion of an exterior surface of said sun exposure bracelet.

3. The sun exposure bracelet of claim 2, wherein said sunscreen reservoir is replenishable.

4. The sun exposure bracelet of claim 3, wherein said flexible band having a material selected from a group consisting of a polymer and a rubber.

5. The sun exposure bracelet of claim 4, wherein said UV exposure indicating sun exposure to the user.

6. The sun exposure bracelet of claim 5, wherein said sun exposure bracelet having an alert for alerting the user when said UV exposure exceeds a predetermined threshold of UV exposure.

7. The sun exposure bracelet of claim 6, wherein said sun exposure bracelet having a speaker and said alert is an audible alert.

8. The sun exposure bracelet of claim 6, wherein said alert is a visual alert on said display for alerting the user when said UV exposure exceeds said predetermined threshold of UV exposure.

9. The sun exposure bracelet of claim 8, wherein said sun exposure bracelet having a rechargeable battery and a charging port for charging said rechargeable battery and supplying power to said display.

10. The sun exposure bracelet of claim 9, wherein said touch-based display selected from a screen consisting of a capacitive touchscreen, an AMOLED touchscreen, an LCD touchscreen, and an E-ink display.

11. A sun exposure wrist bracelet for monitoring UV exposure, the sun exposure wrist bracelet comprising:
a sun exposure bracelet for monitoring UV exposure having a flexible band, a display, a UV sensor, a time keeping module, a temperature sensor, and a sunscreen reservoir;
wherein said flexible band forming a closed loop to selectively conform around a wrist of a user;
wherein said display having a touch-based display including a display of a current time from said time keeping module, a current temperature from said temperature sensor, and a UV exposure from said UV sensor;
wherein said UV sensor detecting UV radiations emitting from the sun onto said sun exposure bracelet;
wherein said detected UV radiations comprising said UV exposure;
wherein said sunscreen reservoir disposed inside a portion of said flexible band having a quantity of sunscreen stored therein; and
further wherein said sunscreen reservoir having a pivoting lid and a nozzle for dispensing said sunscreen.

12. The sun exposure bracelet of claim 11, wherein said UV sensor having a photodetector responsive to said UV radiations.

13. The sun exposure bracelet of claim 12, wherein said UV sensor configured to generate an electrical signal proportional to an intensity of said UV radiations.

14. The sun exposure bracelet of claim 13, wherein said electrical signal transmitted to a microprocessor for calculating a UV index including a numerical rating of the intensity of said UV radiations.

15. The sun exposure bracelet of claim 14, wherein said UV exposure indicating sun exposure to the user.

16. The sun exposure bracelet of claim 15, wherein said sun exposure bracelet having an alert for alerting the user when said UV exposure exceeds a predetermined threshold of said UV index.

17. The sun exposure bracelet of claim 16, wherein said sun exposure bracelet having a speaker and said alert is an audible alert.

18. The sun exposure bracelet of claim 16, wherein said alert is a visual alert on said display for alerting the user when said UV exposure exceeds said predetermined threshold of said UV index.

19. A sun exposure wrist bracelet for monitoring UV exposure, the sun exposure wrist bracelet comprising:
a sun exposure bracelet for monitoring UV exposure having a flexible band, a display, a UV sensor, a time keeping module, a temperature sensor, and a sunscreen reservoir;
wherein said flexible band forming a closed loop to selectively conform around a wrist of a wearer;
wherein said display having a touch-based display including a display of a current time from said time keeping module, a current temperature from said temperature sensor, and a UV exposure from said UV sensor;
wherein said UV sensor detecting UV radiations emitting from the sun onto said sun exposure bracelet;
wherein said detected UV radiations comprising said UV exposure;
wherein said sunscreen reservoir disposed inside a portion of said flexible band having a quantity of sunscreen stored therein;
wherein said sunscreen reservoir having a nozzle for dispensing said sunscreen;
wherein said UV sensor configured to generate an electrical signal proportional to an intensity of said UV radiations;
wherein said electrical signal transmitted to a microprocessor for calculating a UV index including a numerical rating of the intensity of said UV radiations; and
further wherein said sun exposure bracelet having an alert for alerting the wearer when said UV exposure exceeds a predetermined threshold of said UV index.

20. The sun exposure bracelet of claim 19, wherein said UV sensor having a photodetector responsive to said UV radiations, and further wherein said UV exposure indicating sun exposure to the wearer.
